(19) United States
(12) Patent Application Publication
(10) Pub. No.: US 2020/0292874 A1
(43) Pub. Date: Sep. 17, 2020

(54) DISPLAY PANEL AND DISPLAY DEVICE

(71) Applicant: Sharp Kabushiki Kaisha, Sakai City (JP)

(72) Inventors: Noriyuki OHASHI, Sakai City (JP); Yasuhiro KUROE, Sakai City (JP)

(21) Appl. No.: 16/817,675

(22) Filed: Mar. 13, 2020

Related U.S. Application Data
(60) Provisional application No. 62/818,770, filed on Mar. 15, 2019.

(51) Int. Cl. G02F 1/1335; G09G 3/36

(52) U.S. Cl. CPC G02F 1/133512; G09G 3/3611; G02F 2001/133388; G02F 2201/56; G02F 2201/52

(57) ABSTRACT

Display pixel includes colored pixels of n colors. In a case where a colored pixel being one of the colored pixels including the curved line portion and being located at an outermost end side in an array direction is defined as a display end pixel, the array direction being a direction in which the colored pixels are repeatedly arrayed with the colored pixels of the n colors being a unit, a first light blocking portion is provided in line with a shape of the curved line portion in the display end pixel, and a second light blocking portion having a shape and a size substantially the same as a shape and a size of the first light blocking portion is provided in each of the colored pixels of (n−1) colors consecutively arrayed next to the display end pixel toward the display region in the array direction.

### TECHNICAL FIELD

The present invention relates to a display panel and a display device.

### BACKGROUND ART

Liquid crystal display devices whose shape of a display region is formed into a non-rectangular shape, such as a circular shape, have hitherto been known. In such a liquid crystal display device, pixels located at a boundary portion between a display region of a curved shape and a non-display region include both a display region and a non-display region. Therefore, there are problems that smooth display cannot be achieved at the curved line portion, and the color balance is liable to be lost due to occurrence of coloring of a specific color in the pixels located at the boundary portion.

To solve such problems, in a liquid crystal display device described in JP 5112961B, pixels located at the boundary portion of the curved line portion are classified into three types (a normal picture element, an aperture ratio adjustment picture element, and a non-lighting picture element) according to the size of a non-display region included in each pixel, and the size of a light blocking portion to be provided in each pixel is adjusted according to the classification. Specifically, the normal picture element is configured such that the entire region thereof is lighted without providing a light blocking portion, the aperture ratio adjustment picture element is configured such that a partial region thereof is lighted by providing a light blocking portion in another partial region thereof, and the non-lighting picture element is configured to be in a non-lighting state by providing a light blocking portion in its entire region.

### SUMMARY OF INVENTION

However, it is the case with the liquid crystal display device described in JP 5112961B that smooth display is not invariably achieved at the curved line portion, such as in a situation where the entire region of the non-lighting picture element is configured to be a non-lighting state despite the fact that the non-lighting picture element includes both the display region and the non-display region.

The one embodiment of the present invention is made in view of the circumstances as described above, and has an object to achieve smooth display of a shape of a peripheral portion of a display region while maintaining a satisfactory color balance, even even with a display region including a peripheral portion including a curved line portion.

(1) One embodiment of the present invention is a display panel including a plurality of display pixels arrayed in a surface of a substrate,

wherein a boundary between a display region and a non-display region has a shape including a curved line portion,

each of the plurality of display pixels includes colored pixels of n colors including different colored portions, and

in a case where a colored pixel being one of the colored pixels including the curved line portion and being located at an outermost end side in an array direction is defined as a display end pixel, the array direction being a direction in which the colored pixels are repeatedly arrayed with the colored pixels of the n colors being a unit,

a first light blocking portion is provided in line with a shape of the curved line portion in the display end pixel, and

a second light blocking portion having a shape and a size substantially the same as a shape and a size of the first light blocking portion is provided in each of the colored pixels of (n−1) colors consecutively arrayed next to the display end pixel toward the display region in the array direction.

(2) One embodiment of the present invention is the display panel, in addition to (1) described above, wherein the display end pixel includes display end pixels, and the first light blocking portion is provided in all of the display end pixels.

(3) One embodiment of the present invention is the display panel, in addition to (1) or (2) described above, wherein each of the plurality of display pixels includes the colored pixels of three colors including colored portions of red, green, and blue.

(4) One embodiment of the present invention is the display panel, in addition to (3) described above, wherein each of the plurality of display pixels includes the colored pixels of four colors further including a colored portion of white or yellow.

(5) One embodiment of the present invention is the display panel, in addition to any one of (1) to (4) described above, wherein each of the colored pixels has substantially the same shape and size.

(6) One embodiment of the present invention is the display panel, in addition to any one of (1) to (5) described above, wherein the first light blocking portion and the second light blocking portion are made of a light blocking material formed on the substrate.

(7) One embodiment of the present invention is the display panel, in addition to any one of (1) to (6) described above, wherein the display panel is a liquid crystal panel using liquid crystals.

(8) One embodiment of the present invention is a display device including: the display panel of any one of (1) to (7) described above; and an illumination device configured to emit light to be used for display to the display panel.

### Advantageous Effects of Invention

According to one embodiment of the present invention, smooth display of a shape of a peripheral portion of a display region can be achieved while maintaining a satisfactory color balance, even with a display region including a peripheral portion including a curved line portion.

### BRIEF DESCRIPTION OF DRAWINGS

FIG. 1 is a plan view of a liquid crystal display device according to a first embodiment of the present invention.

FIG. 2 is a cross-sectional view of a liquid crystal panel of FIG. 1 taken along the line II-II.

FIG. 3 is an enlarged view of a border line portion III of the liquid crystal panel of FIG. 1.

FIG. 4 is an enlarged view of a liquid crystal panel according to a first comparative example, at a position of a border line portion III of FIG. 1.

FIG. 5 is an enlarged view of a liquid crystal panel according to a second comparative example, at a position of a border line portion III of FIG. 1.

### DESCRIPTION OF EMBODIMENTS

### First Embodiment

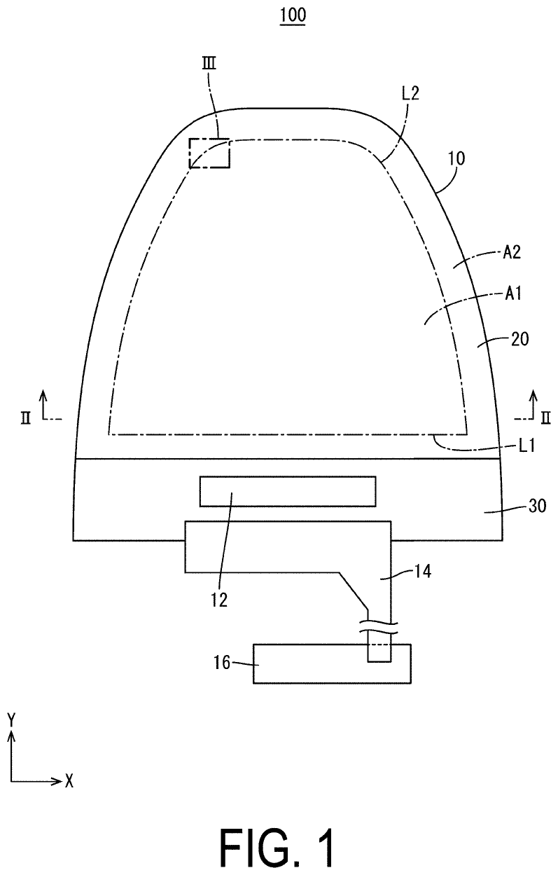

A first embodiment of the present invention will be described with reference to FIG. 1 to FIG. 3. The present embodiment exemplifies a liquid crystal display device 100 including a liquid crystal panel 10. Note that the X axis, the Y axis, and the Z axis are illustrated in a part of the drawings, and each axial direction is illustrated to be a common direction in each drawing. The +Z-axis direction (liquid crystal panel 10 side) herein represents the front side of the liquid crystal display device 100, and its opposite side (−Z-axis direction) represents the back side.

As illustrated in FIG. 1, the liquid crystal display device 100 (one example of a display device) includes the liquid crystal panel 10 (one example of a display panel) whose outer shape in a plan view includes a curved line portion, and an illumination device that is disposed on the back side of the liquid crystal panel 10 and emits light to be used for display to the liquid crystal panel 10. The central portion of the liquid crystal panel 10 is defined as a display region A1 in which an image is displayed. A frame-like outer peripheral portion surrounding the display region A1 is defined as a non-display region A2 in which an image is not displayed. Ideally, the boundary between the display region A1 and the non-display region A2 has a shape including a curved line portion L2 as indicated by the one-dot chain line of FIG. 1, and specifically includes a straight line portion L1 that extends along the X-axis direction and the curved line portion L2 that connects both ends of the straight line portion L1.

In the above-described non-display region A2 on the straight line portion L1 side, an IC chip 12 and a flexible substrate 14 are mounted. The IC chip 12 is an electronic component for driving the liquid crystal panel 10. The flexible substrate 14 is a substrate for connecting a control substrate 16, which supplies various input signals from the outside to the IC chip 12, to the liquid crystal panel 10.

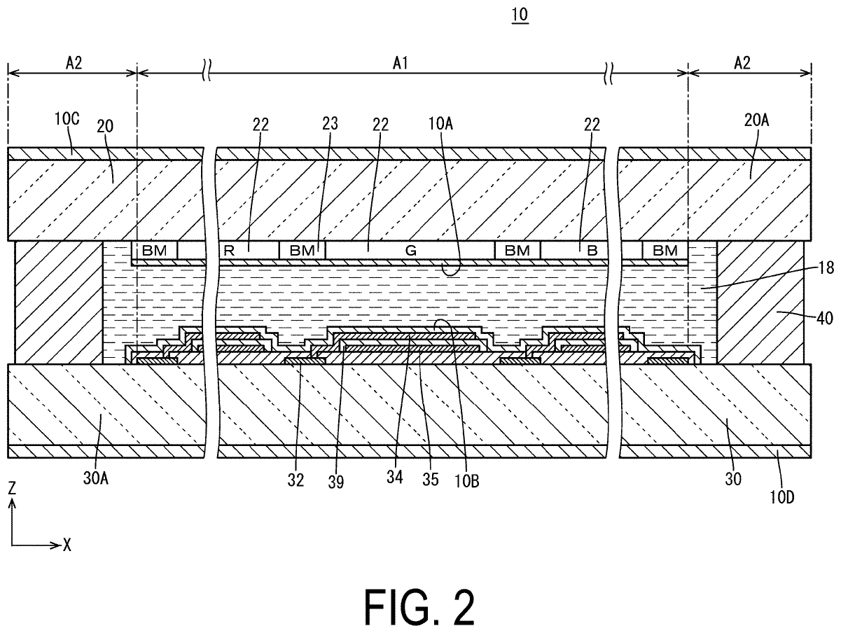

As illustrated in the cross-sectional view of FIG. 2, the liquid crystal panel 10 includes a pair of substrates 20 and 30, and a liquid crystal layer 18 including liquid crystal molecules that change its optical characteristics according to application of an electric field. Both the substrates 20 and 30 constituting the liquid crystal panel 10 are bonded together by a sealant 40 in such a manner that a cell gap as large as the thickness of the liquid crystal layer 18 is maintained therebetween. The sealant 40 is disposed to surround the display region A1. Of both the substrates 20 and 30, the substrate 20 located on the front side (front surface side) serves as a CF substrate (counter substrate) 20, and the substrate 30 located on the back side (back surface side) serves as an array substrate (active matrix substrate) 30. Alignment films 10A and 10B for aligning liquid crystal molecules included in the liquid crystal layer 18 are formed on the inner surface side of both the substrates 20 and 30, respectively. Polarizers 10C and 10D are respectively bonded to the outer surface side of glass substrates 20A and 30A that respectively constitute both the substrates 20 and 30.

Next, a configuration inside the display region A1 in the array substrate 30 and the CF substrate 20 will be described. An operation mode of the liquid crystal panel 10 according to the present embodiment is a Fringe Field Switching (FFS) mode. As illustrated in FIG. 2, pixel electrodes 34 and common electrodes 35 are formed together on the array substrate 30 side. Each pixel electrode 34 and each common electrode 35 interpose an insulating film 39 so that the pixel electrode 34 and the common electrode 35 are disposed in different layers. On the array substrate 30, thin film transistors (TFTs) 32 each serving as a switching element and the pixel electrodes 34 connected to respective TFTs 32 are arrayed in a matrix shape in a plan view. Through use of the potential of the pixel electrode 34, the electric field to be applied to the liquid crystal layer 18 is controlled, the alignment state of the liquid crystal molecules is appropriately switched, and the liquid crystal panel 10 is thereby driven.

On the inner surface side (liquid crystal layer 18 side) of the glass substrate 20A constituting the CF substrate 20, as illustrated in FIG. 2, color filters are formed in line. The color filters are disposed in a matrix shape at positions to overlap respective pixel electrodes 34 of the array substrate 30 in a plan view. The color filters include respective colored portions 22 of red (R), green (G), and blue (B), for example. A black matrix 23 substantially having a lattice shape for preventing color mixing is formed between the respective colored portions 22 constituting the color filters. The black matrix 23 is made of a light blocking material such as titanium (Ti), for example.

In the liquid crystal panel 10, a set of colored portions 22 of three colors of red (R), green (G), and blue (B) and their respective opposing three pixel electrodes 34 constitutes one display pixel 90. The display pixel 90 includes three colored pixels (subpixels) 92, i.e., a red pixel including a colored portion 22 for R, a green pixel including a colored portion 22 for G, and a blue pixel including a colored portion 22 for B. In other words, each display pixel 90 includes a plurality of colors (three colors) of colored pixels 92 including different colored portions 22. In the following description, a suffix R, G, or B is added to a reference sign as in “red pixel 92R”, “green pixel 92G”, or “blue pixel 92B” to distinguish the colors of the colored pixels, whereas such a suffix is not added as in “colored pixel 92” to make collective reference without distinguishing the colors.

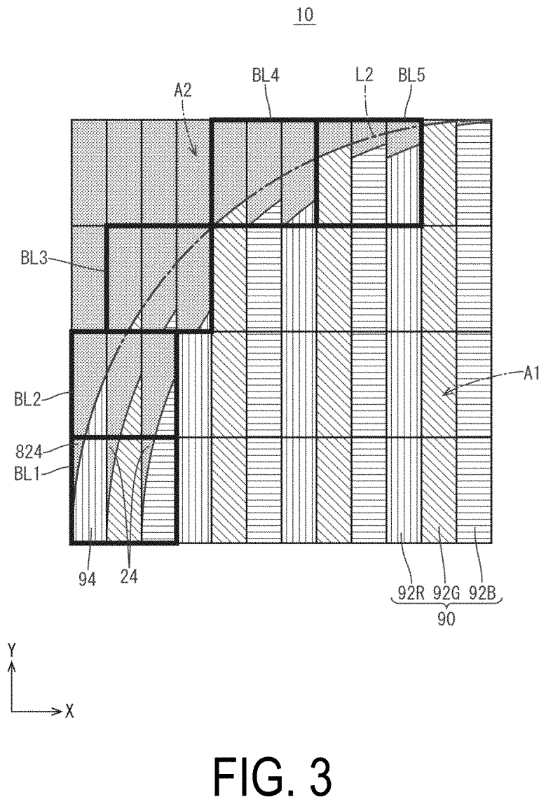

As illustrated in FIG. 3, on a substrate surface of the liquid crystal panel 10, the colored pixels 92 are repeatedly arrayed along a row direction (X-axis direction) with colored pixels 92 of a plurality of colors (three colors) being a unit so as to constitute a pixel group, and a large number of such pixel groups are arrayed along a column direction (Y-axis direction). Each colored pixel 92 has substantially the same shape (rectangular shape), and has substantially the same size. Regarding the colored pixels 92, as illustrated in FIG. 3, on the central side of the display region A1, the entire region within each pixel belongs to the display region A1, and therefore the red pixel 92R, the green pixel 92G, and the blue pixel 92B have an equal aperture ratio, and the display pixels 90 are displayed with a satisfactory color balance. In contrast, the colored pixels 92 including the curved line portion L2 include both the display region A1 and the non-display region A2, with the curved line portion L2 being a boundary.

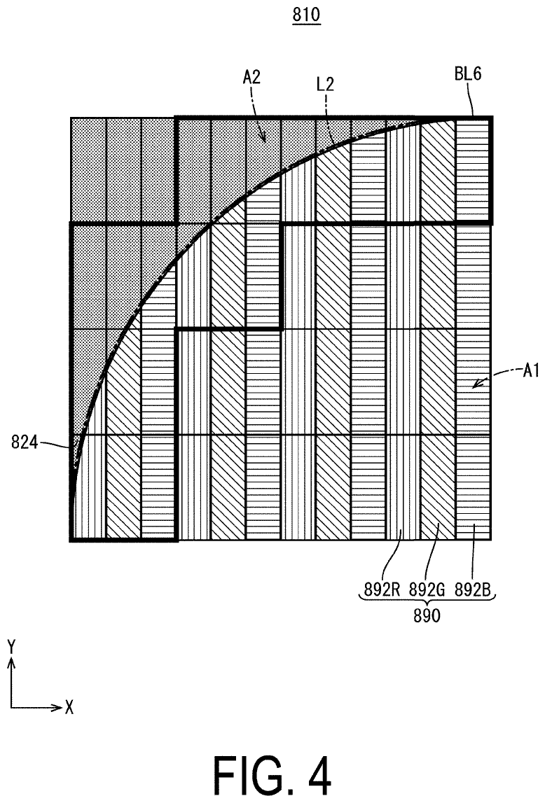

Incidentally, as illustrated in a liquid crystal panel 810 according to a first comparative example of FIG. 4, provided that display is performed by separating a lighting region and a non-lighting (light blocking) region along an ideal curved line portion L2 in colored pixels 892 including the curved line portion L2, the boundary between the lighting region and the light blocking region substantially matches the curved line portion L2, and therefore the outline of the peripheral portion of the display region A1 is smoothly displayed. In the first comparative example, in the colored pixels 892 including the curved line portion L2, a first light blocking portion 824 for blocking light from the illumination device is provided in line with the shape of the curved line portion L2. However, such light blocking adjustment performed along the curved line portion L2 makes the shape and the size of a red pixel 892R, a green pixel 892G, and a blue pixel 892B to be lighted different from one another at the peripheral portion (portion enclosed by the border line portion BL6 in FIG. 4) of the display region A1, and therefore the color balance of display pixels 890 is lost at the peripheral portion, and coloring is caused. Note that the first light blocking portion 824 is made of a light blocking material such as titanium (Ti), for example, and is formed on the CF substrate 20, in a similar manner to the black matrix 23.

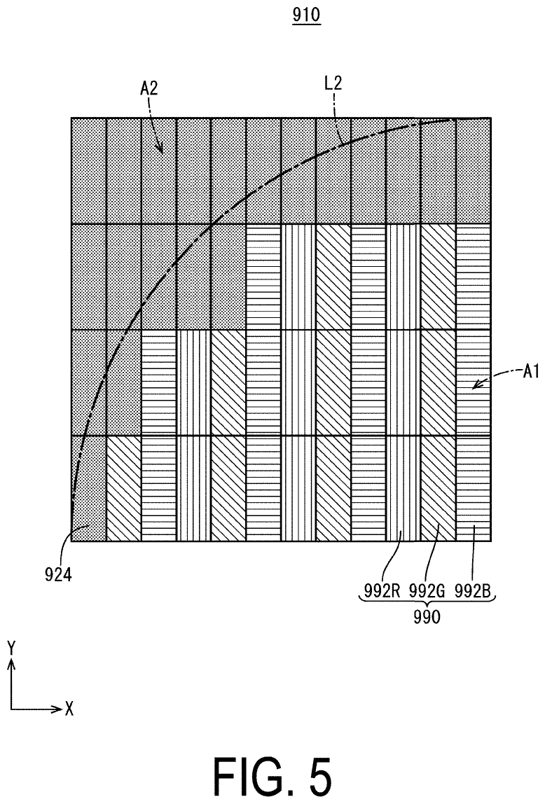

As illustrated in a liquid crystal panel 910 according to a second comparative example of FIG. 5, provided that light blocking adjustment is performed on the peripheral portion of the display region A1 per colored pixel 992, a red pixel 992R, a green pixel 992G, and a blue pixel 992B to be lighted have the same shape and size, and the color balance is maintained satisfactorily. In the second comparative example, a first light blocking portion 924 is provided so that the entire region of the colored pixels 992 including the curved line portion L2 a non-lighting state, which enables light blocking adjustment per colored pixel 992. However, such light blocking adjustment makes the shape of the peripheral portion of the display region A1 a stepped shape as illustrated in FIG. 5, and smooth display is not be achieved.

In view of this, in the present embodiment, as illustrated in FIG. 3, a second light blocking portion 24 as described below is provided, as well as the first light blocking portion 824 having a shape in line with the curved line portion L2 as in the first comparative example. First of all, a colored pixel 92 that is one of the colored pixels 92 including the curved line portion L2 and that is located at the outermost end side in an array direction (X-axis direction) is defined as a display end pixel 94. The array direction is a direction in which the colored pixels 92 are repeatedly arrayed with colored pixels 92 of three colors being a unit. In this case, the second light blocking portion 24 having a shape and a size substantially the same as those of the first light blocking portion 824 of the display end pixel 94 is provided in each of colored pixels 92 of two colors that are consecutively arrayed next to the display end pixel 94 toward the display region A1 in the array direction (toward a side opposite to the end side). Further detailed description is given by taking an example of the display pixels 90 enclosed by the border line portion BL1 of FIG. 3. The display pixel 90 in the border line portion BL1 includes a red pixel 92R including the curved line portion L2. A display end pixel 94 that is one of three colored pixels 92R, 92G, and 92B constituting the display pixel 90 and that is located at the outermost end side in the array direction corresponds to the red pixel 92R. In this case, the second light blocking portion 24 having a shape and a size substantially the same as those of the first light blocking portion 824 of the display end pixel 94 (red pixel 92R) is provided in each of colored pixels 92 of two colors (green pixel 92G and blue pixel 92B) that are consecutively arrayed next to the display end pixel 94 toward the display region A1 in the array direction (from the left side to the right side in the X-axis direction). In a similar manner, regarding the display pixels 90 indicated by the border line portions BL2, BL3, BL4, and BL5 of FIG. 3 as well, the first light blocking portion 824 is provided in the display end pixel 94, and the second light blocking portion 24 is provided in each of colored pixels 92 of two colors that are consecutively arrayed next to the display end pixel 94 toward the display region A1 in the array direction. The second light blocking portion 24 is made of a light blocking material such as titanium (Ti), and is formed on the CF substrate 20, in a similar manner to the black matrix 23 and the first light blocking portion 824.

According to this configuration, regarding the display pixels 90 including the colored pixels 92 including the curved line portion L2, colored pixels 92 of three colors constituting the display pixel 90 are lighted in line with the shape of the display end pixel 94, and therefore the colored pixels 92 of the three colors have a lighting region of the same shape and the same size in their corresponding display pixel 90. As a result, also in the display pixel 90, the colored pixels 92 have an equal aperture ratio, and a satisfactory color balance can be maintained. Although the shape of the lighting region of each colored pixel 92 is arranged to match the shape of the lighting region of the display end pixel 94, the shape of the curved line portion of the display end pixel 94 matches the shape of the curved line portion L2. This enables smooth display of the shape of the peripheral portion (outline) of the display region A1.

The first light blocking portion 894 having a shape in line with the shape of the curved line portion L2 is provided in all of the display end pixels 94. This configuration prevents a situation that the entire region of some of the display end pixels 94 enters a non-lighting state, which is the case with JP 5112961B. As a result, smooth display of the shape of the peripheral portion (outline) of the display region A1 can be secured.

Note that the number of colors and the combination of the colored portions 22 of the display pixel 90 can be modified as appropriate within the range of n different colors (n: a natural number of 2 or greater). The above description takes an example of a case where n is 3 (n=3). However, for example, in a case where n is 4 (n=4) with another colored portion of white (W) or yellow (Y) being provided in addition to R, G, and B, each display pixel 90 includes four colors of colored pixels 92, and thus color reproducibility can be enhanced, for example.

### OTHER EMBODIMENTS

The present invention is not limited to the embodiments described above and illustrated by the drawings, and embodiments such as those described below are also included within the technical scope of the present invention.

(1) The above embodiments illustrate one example of the shape of the display region. The shape, however, is not limited to the above shape as long as the shape includes a curved line. The non-display region is not limited to an outer peripheral portion. For example, in a case where the display region has a donut-like shape, both of an inner peripheral portion and an outer peripheral portion of the donut-like shape correspond to the non-display region, and the boundary between the display region and the non-display region exists both on the inner peripheral side and the outer peripheral side.

(2) Each of the above embodiments exemplifies a liquid crystal panel whose operation mode is an FFS mode. The operation mode, however, may be another operation mode, such as an in-plane switching (IPS) mode and a vertical alignment (VA) mode. The liquid crystal panel may also be provided with a touch panel function of detecting a position of user's input, based on a display image.

(3) Each of the above embodiments exemplifies a liquid crystal panel as the display panel. However, the present invention can also be applied to other types of display panels (such as an organic EL panel, a plasma display panel (PDP), an electrophoretic display panel (EPD), and a display panel of micro electro mechanical systems (MEMS)).

1. A display panel comprising a plurality of display pixels arrayed in a surface of a substrate,
wherein a boundary between a display region and a non-display region has a shape including a curved line portion,
each of the plurality of display pixels includes colored pixels of n colors including different colored portions, and
in a case where a colored pixel being one of the colored pixels including the curved line portion and being located at an outermost end side in an array direction is defined as a display end pixel, the array direction being a direction in which the colored pixels are repeatedly arrayed with the colored pixels of the n colors being a unit,
a first light blocking portion is provided in line with a shape of the curved line portion in the display end pixel, and
a second light blocking portion having a shape and a size substantially the same as a shape and a size of the first light blocking portion is provided in each of the colored pixels of (n−1) colors consecutively arrayed next to the display end pixel toward the display region in the array direction.

2. The display panel according to claim 1,
wherein the display end pixel includes display end pixels, and the first light blocking portion is provided in all of the display end pixels.

3. The display panel according to claim 1,
wherein each of the plurality of display pixels includes the colored pixels of three colors including colored portions of red, green, and blue.

4. The display panel according to claim 3,
wherein each of the plurality of display pixels includes the colored pixels of four colors further including a colored portion of white or yellow.

5. The display panel according to claim 1,
wherein each of the colored pixels has substantially the same shape and size.

6. The display panel according to claim 1,
wherein the first light blocking portion and the second light blocking portion are made of a light blocking material formed on the substrate.

7. The display panel according to claim 1,
wherein the display panel is a liquid crystal panel using liquid crystals.

8. A display device comprising:
the display panel according to claim 1; and
an illumination device configured to emit light to be used for display to the display panel.
